(19) United States
(12) Patent Application Publication
(10) Pub. No.: US 2025/0145890 A1
(43) Pub. Date: May 8, 2025

(54) SOLVENT EXTRACTION METHOD FOR PETROLEUM SLUDGE/OIL SAND ASSISTED BY PARTICLE DISPERSANT

(71) Applicant: Shandong University, Jinan City (CN)

(72) Inventors: Dejun SUN, Jinan City (CN); Wenwen DI, Jinan City (CN); Wenchao LU, Jinan City (CN); Jifei HUA, Jinan City (CN); Zhenghe XU, Shenzhen City (CN)

(73) Assignee: Shandong University, Jinan City (CN)

(21) Appl. No.: 18/737,723

(22) Filed: Jun. 7, 2024

(30) Foreign Application Priority Data
Nov. 6, 2023 (CN) 202311470308.8

(51) Int. Cl. C10G 1/04; B01D 11/04; C02F 11/00; C02F 11/127; C02F 101/32; C02F 103/10

(52) U.S. Cl. CPC C10G 1/04; B01D 11/0492; C02F 11/002; C02F 11/127; C02F 2101/32; C02F 2103/10; C10G 2300/44

(57) ABSTRACT

Provided is a solvent extraction method for a petroleum sludge/oil sand assisted by a particle dispersant, including: mixing a solution dissolved with the particle dispersant and the petroleum sludge/oil sand to obtain a mixture, and subjecting the mixture to solvent extraction and separation to obtain a solid phase particle and an oil-carrying liquid phase; wherein the particle dispersant includes one compound selected from the group consisting of a polyoxyethylene alkyl ether carboxylic acid, a polyoxypropylene polyoxyethylene alkyl ether carboxylic acid, and dodecylbenzene sulfonic acid; and a solvent used in the solution dissolved with the particle dispersant comprises one or more selected from the group consisting of cycloalkane and toluene.

### CROSS REFERENCE TO RELATED APPLICATION

This patent application claims the benefit and priority of Chinese Patent Application No. 2023114703088 filed with the China National Intellectual Property Administration on Nov. 6, 2023, and entitled with “SOLVENT EXTRACTION METHOD FOR PETROLEUM SLUDGE/OIL SAND ASSISTED BY PARTICLE DISPERSANT”, the disclosure of which is incorporated by reference herein in its entirety as part of the present application.

### TECHNICAL FIELD

The present disclosure belongs to the technical field of chemical separation, and specifically relates to a solvent extraction method for a petroleum sludge/oil sand assisted by a particle dispersant.

### BACKGROUND

With the rapid development of the global economy, the demand for petroleum is increasing, and a large amount of petroleum sludge is generated during the mining, transportation, storage, and refining of conventional crude oil. These pollutants can threaten the ecological environment and human health if not handled properly. The resource and harmless treatment of petroleum sludge is one of the problems faced by the petroleum industry. In addition, as the demand for conventional petroleum outstrips supply, attention is turning to unconventional petroleum resources. Oil sands contain a large amount of crude oil resources, accounting for 30% of the global petroleum reserves, and are increasingly valued by the world as an important reserve resource.

The solvent extraction method is commonly used in the recovery of crude oil from the petroleum sludge/oil sand. Based on the rule of “like dissolve like”, a solvent that is selected or prepared according to the solubility parameter close to that of the crude oil is subjected to extraction. However, asphaltene aggregates are dispersed in the solvent, and the solubility parameter is not the only factor affecting the solvent extraction. Petroleum sludge/oil sand contains a small amount of water, the mineral particles aggregate due to the water bound to particles generating attraction during the solvent extraction process, the asphaltene aggregates are trapped in mineral particle aggregates, making the separation of the asphaltene aggregates difficult and resulting in a high residual oil rate.

Patent CN113881449B discloses a low-temperature pyrolysis treatment method for an oily waste. The oily waste is deasphalted with dodecylbenzene sulfonic acid in an n-heptane solution, a white oil solution, and a kerosene solution before pyrolysis. Asphaltenes accumulate significantly in poor solvents such as n-heptane, white oil, and kerosene. Dodecylbenzene sulfonic acid, as a desirable asphaltene dispersant, can effectively promote asphaltene dispersion. The deasphalted oily waste is subjected to thermal desorption at a temperature of 200° C. to 400° C. to reduce the residual oil rate of solid particles to not more than 1 wt %. Patent CN113754213A discloses use of a pretreatment liquid in a petroleum sludge. The asphaltene dispersants, dodecylbenzene sulfonic acid, p-dodecylphenol and N,N-di(hydroxyethyl)cocamide, are mixed with non-polar solvents, n-heptane, n-dodecane, white oil and gas-to-liquid, and the like to prepare a pretreatment liquid. The pretreatment liquid is mixed with an petroleum sludge to assist in the removal of asphaltenes, and then the deasphalted petroleum sludge is subjected to chemical thermal cleaning at a temperature of 20° C. to 60° C. to reduce the residual oil rate to not more than 1 wt %. The extraction solvents in the above patents are linear alkanes such as n-heptane and white oil. These linear alkane solvents have a solubility parameter that is quite different from that of asphaltenes, and asphaltenes accumulate seriously in such alkane solvents. The asphaltene dispersant dodecylbenzene sulfonic acid is added to disperse asphaltenes without considering the dispersion of mineral particles (if the asphaltenes are not dispersed, the solid phase particles and the asphaltenes cannot be separated eventually even if the mineral particles are dispersed). Moreover, further treatment is required after the removal of asphaltenes to reduce the residual oil rate to not more than 1 wt %.

### SUMMARY

In view of this, an object of the present disclosure is to provide a solvent extraction method for a petroleum sludge/oil sand assisted by a particle dispersant. In the present disclosure, the method is aimed at the agglomeration of mineral particles during the solvent extraction, and can separate the trapped asphaltene aggregates from the mineral particles and reduce the residual oil rate of the solid phase particles.

To achieve the above object, the present disclosure provides the following technical solutions:

The present disclosure provides a solvent extraction method for a petroleum sludge/oil sand assisted by a particle dispersant, including:
mixing a solution dissolved with the particle dispersant and the petroleum sludge/oil sand to obtain a mixture, and subjecting the mixture to solvent extraction and separation to obtain a solid phase particle and an oil-carrying liquid phase;
wherein the particle dispersant includes one compound selected from the group consisting of a polyoxyethylene alkyl ether carboxylic acid, a polyoxypropylene polyoxyethylene alkyl ether carboxylic acid, and dodecylbenzene sulfonic acid; and
a solvent used in the solution dissolved with the particle dispersant includes one or more selected from the group consisting of cycloalkane and toluene.

In some embodiments, the separation is conducted by a mode selected from the group consisting of gravity field sedimentation and centrifugation; the gravity field sedimentation is conducted for 0.5 min to 60 min; and the centrifugation is conducted at a speed of 500 r/min to 3,000 r/min for 3 min to 30 min.

In some embodiments, the petroleum sludge/oil sand has an oil content of 5 wt % to 30 wt %, a water content of 4 wt % to 20 wt %, and a solid content of 57 wt % to 92 wt %.

In some embodiments, a mass ratio of the petroleum sludge/oil sand to the solution dissolved with the particle dispersant is in a range of 1:(0.5-3).

In some embodiments, the cycloalkane includes cyclohexane and/or cyclopentane.

In some embodiments, a mass of the particle dispersant accounts for not more than 2.5% of a mass of the solution dissolved with the particle dispersant.

In some embodiments, the solvent extraction is conducted under stirring; and the stirring is conducted at a speed of 300 r/min to 2,000 r/min for 10 min to 120 min.

In some embodiments, after obtaining the solid phase particle, the method further includes subjecting the solid phase particle to washing and drying in sequence to obtain a dried solid phase particle; and the drying is conducted at a temperature of 70° C. to 110° C.

In some embodiments, after the drying, the method further includes subjecting the dried solid phase particle to low-temperature thermal desorption to remove a residual solvent; and the low-temperature thermal desorption is conducted at a temperature of 250° C. to 350° C. for 30 min to 60 min.

In some embodiments, after obtaining the oil-carrying liquid phase, the method further includes subjecting the oil-carrying liquid phase to rotary evaporation to obtain a crude oil and a solvent.

The present disclosure provides a solvent extraction method for a petroleum sludge/oil sand assisted by a particle dispersant, including: mixing a solution dissolved with the particle dispersant and the petroleum sludge/oil sand to obtain a mixture, and subjecting the mixture to solvent extraction and separation to obtain a solid phase particle and an oil-carrying liquid phase; wherein the particle dispersant includes one compound selected from the group consisting of a polyoxyethylene alkyl ether carboxylic acid, a polyoxypropylene polyoxyethylene alkyl ether carboxylic acid, and dodecylbenzene sulfonic acid; and a solvent used in the solution dissolved with the particle dispersant includes one or more selected from the group consisting of cycloalkane and toluene. In the present disclosure, the petroleum sludge/oil sand is a mixed system of a crude oil, water, and mineral particles, wherein the water can cause the agglomeration of the mineral particles, and the asphaltene aggregates are trapped in these agglomerations. In the present disclosure, one or more of the cycloalkane and toluene serve as a solvent. The solubility parameter of the cycloalkane solvents is similar to that of the asphaltenes. The asphaltenes have a lower degree of aggregation and a smaller aggregate size. Therefore, there is no need to consider the dispersion of asphaltenes, thereby highlighting the agglomeration of mineral particles. In the present disclosure, the repulsive force between the mineral particles can be increased by the addition of the particle dispersant, which causes the mineral particles to disperse, thereby releasing trapped asphaltene aggregates and reducing the residual oil rate of the solid phase particle. After drying, the residual oil rate of the solid phase particle can be reduced to not more than 1%. After the residual solvent is removed by low-temperature thermal desorption at a temperature of 250° C. to 350° C., the residual oil content of the solid phase particle can reach not more than 0.1%, which meets higher environmental emission requirements. The maximum recovery rate of the crude oil is close to 100%, indicating a higher crude oil quality.

Furthermore, in the present disclosure, a dispersion system of the solid phase particle and the asphaltene aggregates can be quickly separated by controlling a settling time and a centrifugal speed under a gravity field.

In addition, in the present disclosure, the particle dispersant and the organic solvent each have a low toxicity, and the organic solvent has a low boiling point and is easy to recover. The method according to the present disclosure has the advantages such as simple, efficient, and low in both energy consumption and toxicity, and subverts the traditional theory, the rule of “like dissolve like”, thereby achieving the goal of “no sand in oil while no oil in sand”.

### BRIEF DESCRIPTION OF THE DRAWINGS

To illustrate the technical solutions in the examples of the present disclosure or in the prior art more clearly, the drawings required in the examples will be briefly described below. Apparently, the drawings described below are merely some examples of the present disclosure, and other drawings can be obtained from these drawings by those of ordinary skill in the art without creative efforts.

FIG. 1 shows a flow chart for the solvent extraction of the petroleum sludge according to an embodiment of the present disclosure.

FIG. 2 shows a flow chart for the solvent extraction of the oil sand according to an embodiment of the present disclosure.

### DETAILED DESCRIPTION OF THE EMBODIMENTS

The present disclosure provides a solvent extraction method for a petroleum sludge/oil sand assisted by a particle dispersant, including:
mixing a solution dissolved with the particle dispersant and the petroleum sludge/oil sand to obtain a mixture, and subjecting the mixture to solvent extraction and separation to obtain a solid phase particle and an oil-carrying liquid phase.

In some embodiments of the present disclosure, the solid phase particle includes mineral particles.

In some embodiments of the present disclosure, the oil-carrying liquid phase includes an asphaltene suspension.

In the present disclosure, the particle dispersant includes one compound selected from the group consisting of a polyoxyethylene alkyl ether carboxylic acid, a polyoxypropylene polyoxyethylene alkyl ether carboxylic acid, and dodecylbenzene sulfonic acid. In some embodiments, the polyoxyethylene alkyl ether carboxylic acid includes one compound selected from the group consisting of polyoxyethylene alkyl ether carboxylic acid C₁₂E₉Ac, polyoxyethylene alkyl ether carboxylic acid C₁₈E₉Ac, polyoxyethylene alkyl ether carboxylic acid C₁₂E_{2.5}Ac, and polyoxyethylene alkyl ether carboxylic acid C₁₈E₂Ac; and the polyoxypropylene polyoxyethylene alkyl ether carboxylic acid includes polyoxypropylene polyoxyethylene alkyl ether carboxylic acid C₁₃P₃E_{5.5}Ac. In the present disclosure, a solvent used in the solution dissolved with the particle dispersant includes one or more selected from the group consisting of cycloalkane and toluene. In some embodiments, the cycloalkane includes cyclohexane and/or cyclopentane. In some embodiments of the present disclosure, a mass of the particle dispersant accounts for not more than 2.5%, preferably 0.5% to 2.0%, and more preferably 1% to 1.75% of a mass of the solution dissolved with the particle dispersant.

In some embodiments of the present disclosure, the petroleum sludge/oil sand has an oil content of 5 wt % to 30 wt %, preferably 8 wt % to 25 wt %, and more preferably 12 wt % to 20 wt %; the petroleum sludge/oil sand has a water content of 4 wt % to 20 wt %, preferably 6 wt % to 18 wt %, and more preferably 8 wt % to 15 wt %; the petroleum sludge/oil sand has a solid content of 57 wt % to 92 wt %, preferably 60 wt % to 88 wt %, and more preferably 65 wt % to 75 wt %. In some embodiments of the present disclosure, a mass ratio of the petroleum sludge/oil sand to the solution dissolved with the particle dispersant is in a range of 1:(0.5-3), preferably 1:(0.8-2.5), and more preferably 1:(1-2.2).

In some embodiments of the present disclosure, the solvent extraction is conducted under stirring; the stirring is conducted at a speed of 300 r/min to 2,000 r/min, preferably 450 r/min to 1,800 r/min, and more preferably 600 r/min to 1,500 r/min; and the stirring is conducted for 10 min to 120 min, preferably 20 min to 100 min, and more preferably 40 min to 180 min.

In some embodiments of the present disclosure, the separation is conducted by a mode selected from the group consisting of gravity field sedimentation and centrifugation; the gravity field sedimentation is conducted for 0.5 min to 60 min, preferably 5 min to 50 min, and more preferably 10 min to 40 min; the centrifugation is conducted at a speed of 500 r/min to 3,000 r/min, preferably 650 r/min to 2,500 r/min, and more preferably 800 r/min to 2,000 r/min; and the centrifugation is conducted for 3 min to 30 min, preferably 8 min to 25 min, and more preferably 10 min to 20 min. There are no special requirements on the process of the gravity field sedimentation, which is specifically conducted by standing in an example. In the present disclosure, the dispersion system of the solid phase particle and the asphaltene aggregates can be quickly separated by controlling a settling time and a centrifugal speed under a gravity field.

In some embodiments of the present disclosure, after obtaining the solid phase particle, the method further includes subjecting the solid phase particle to washing and drying in sequence to obtain a dried solid phase particle. In some embodiments of the present disclosure, the washing is conducted by rinsing. In a specific embodiment of the present disclosure, a solvent used in the washing is a corresponding solvent dissolved with the particle dispersant. In some embodiments, the drying is conducted at a temperature of 70° C. to 110° C., preferably 75° C. to 105° C., and more preferably 80° C. to 100° C. There is no special requirement on the drying time, as long as the solid phase particle can be dried to a constant weight. In some embodiments of the present disclosure, after the drying, the method further includes subjecting the dried solid phase particle to low-temperature thermal desorption to remove a residual solvent; the low-temperature thermal desorption is conducted at a temperature of 250° C. to 350° C., preferably 270° C. to 330° C., and more preferably 285° C. to 320° C.; and the low-temperature thermal desorption is conducted for 30 min to 60 min, preferably 35 min to 55 min, and more preferably 40 min to 50 min. In some embodiments of the present disclosure, the dried solid phase particle is placed in a muffle furnace to allow for the low-temperature thermal desorption. Heating under a nitrogen atmosphere can further evaporate the solvent remaining on the solid particle, thus reducing the residual oil content and meeting higher environmental emission requirements.

In some embodiments of the present disclosure, after obtaining the oil-carrying liquid phase, the method further includes subjecting the oil-carrying liquid phase to rotary evaporation to obtain a crude oil and a solvent.

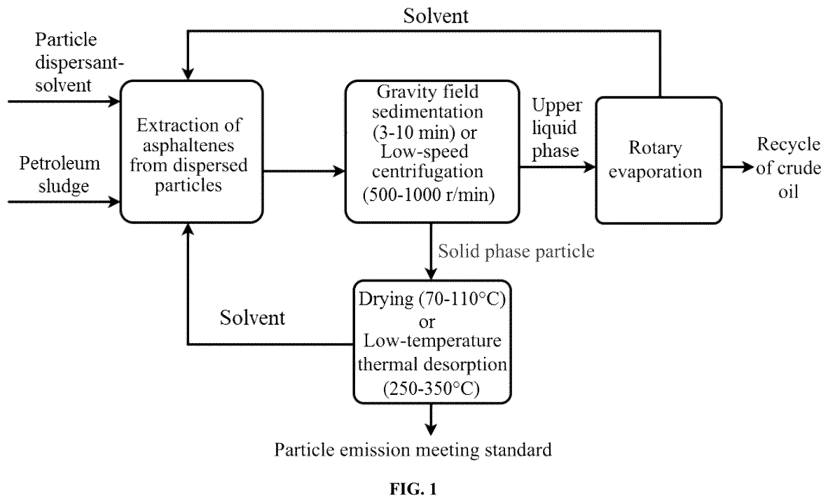

FIG. 1 shows a flow chart for the solvent extraction of the petroleum sludge according to an embodiments of the present disclosure. As shown in FIG. 1, the solution dissolved with the particle dispersant is mixed with the petroleum sludge to obtain a mixture, the mixture is subjected to solvent extraction, and the resulting product is subjected to solid-liquid separation by controlling a settling time or centrifugal speed under a gravity field sedimentation to obtain a solid phase particle and an oil-carrying liquid phase. After the separation, the solid phase particle is dried at different temperatures or subjected to low-temperature thermal desorption to remove the residual solvent. After the separation, the oil-carrying liquid phase is subjected to rotary evaporation to recover a crude oil and reuse a solvent.

In order to further illustrate the present disclosure, the particle dispersant-assisted solvent extraction method for a petroleum sludge/oil sand provided by the present disclosure will be described in detail below with reference to the drawings and examples, but they should not be constructed as limiting the scope of the present disclosure.

### Example 1

A certain petroleum sludge from Shengli (having an oil content of 28 wt %, a water content of 15 wt %, a solid content of 57 wt %, and an asphaltene content of 5.91 wt %) was taken as an example. Polyoxyethylene alkyl ether carboxylic acid C₁₂E₉Ac was dissolved in cyclohexane to prepare a 0.5% C₁₂E₉Ac-cyclohexane solution (where 0.5% was a percentage that a mass of the C₁₂E₉Ac accounted for a total mass of the C₁₂E₉Ac-cyclohexane solution). 2 g of the petroleum sludge was mixed with 2 g of the cyclohexane solution and then stirred at 500 r/min for 30 min. A resulting mixed system was allowed to stand under a gravity field for 10 min and then separated to obtain a lower solid phase particle and an upper oil-carrying liquid phase. The solid phase particle was washed with 1 g of cyclohexane and then placed in an oven at 80° C., and a residual oil content of the solid phase particle after drying is shown in Table 1. In order to make the solid phase particle meet higher environmental emission standards, the solid phase particle was subjected to low-temperature thermal desorption at 350° C. to remove a residual solvent, and a residual oil content of the solid phase particle after thermal desorption is shown in Table 1. The upper oil-carrying liquid phase was subjected to rotary evaporation to recover a crude oil and reuse cyclohexane.

### Comparative Example 1

The steps were the same as those in Example 1, except that the polyoxyethylene alkyl ether carboxylic acid C₁₂E₉Ac was not added to prepare a 0% C₁₂E₉Ac-cyclohexane solution. The residual oil contents of the solid phase particles after drying and thermal desorption are shown in Table 1.

TABLE 1
Residual oil contents of the solid
phase particles after treatment (%)

| | | Residual oil | Residual oil |
|---|---|---|---|
| | | content of | content of the |
| | | the solid | solid phase |
| | | phase particle | particle after |
| | C₁₂E₉Ac | after drying | thermal desorption |
| SN | concentration (%) | at 80° C. | at 350° C. |
| Comparative | 0 | 2.87 | 0.60 |
| Example 1 | | | |
| Example 1 | 0.5 | 0.89 | 0.38 |

The results of Example 1 and Comparative Example 1 show that for the system without the addition of a particle dispersant, after solvent extraction, the residual oil content of the solid phase particle after drying is relatively high, due to the agglomeration of the mineral particles causing asphaltenes to be trapped and unable to be separated during solvent extraction, resulting in a high residual oil content of the solid phase particle after drying. After the addition of the particle dispersant, polyoxyethylene alkyl ether carboxylic acid C₁₂E₉Ac, the residual oil content of the solid phase particles are significantly reduced, due to the release of the asphaltenes from C₁₂E₉Ac dispersing mineral particles, thereby reducing the residual oil content of the solid phase particle. The recovery rate of crude oil in this example is close to 100%. No water and solid phase particle are detected in the recovered crude oil, and the quality of the crude oil is high, while the cyclohexane can be recycled.

### Examples 2 to 5

A certain petroleum sludge from the Safety and Environmental Technology Research Institute of China National Petroleum Corporation (CNPC) (having an oil content of 6.9 wt %, a water content of 12.6 wt %, a solid content of 80.5 wt %, and an asphaltene content of 0.51 wt %) was taken as an example. Polyoxyethylene alkyl ether carboxylic acid C₁₂E₉Ac was dissolved in cyclohexane to prepare 0.10%, 0.25%, 0.50%, and 0.75% C₁₂E₉Ac-cyclohexane solutions (where 0.10%, 0.25%, 0.50%, and 0.75% were percentages that a mass of the C₁₂E₉Ac accounted for a total mass of the C₁₂E₉Ac-cyclohexane solution, respectively). 2 g of the petroleum sludge was respectively mixed with 2 g of the cyclohexane solutions with different concentrations and then stirred at 500 r/min for 30 min. A resulting mixed systems were allowed to stand under a gravity field for 5 min and then separated to obtain lower solid phase particles and upper oil-carrying liquid phases. The solid phase particles were washed with 1 g of cyclohexane and then placed in an oven at 70° C., and residual oil contents of the dried solid phase particles are shown in Table 2. In order to make the solid phase particles meet higher environmental emission standards, the solid phase particles were subjected to low-temperature thermal desorption at 300° C. to remove residual solvents, and residual oil contents of the solid phase particles after thermal desorption are shown in Table 2. The upper oil-carrying liquid phases were subjected to rotary evaporation to recover crude oils and reuse cyclohexane.

### Comparative Example 2

The steps were the same as those in Example 2, except that the polyoxyethylene alkyl ether carboxylic acid C₁₂E₉Ac was not added to prepare a 0% C₁₂E₉Ac-cyclohexane solution. The residual oil contents of the solid phase particles after drying and thermal desorption are shown in Table 2.

TABLE 2
Residual oil contents of the solid
phase particles after treatment (%)

| | | Residual oil | Residual oil |
|---|---|---|---|
| | | content of | content of the |
| | | the solid | solid phase |
| | | phase particle | particle after |
| | C₁₂E₉Ac | after drying | thermal desorption |
| SN | concentration (%) | at 70° C. | at 300° C. |
| Comparative | 0 | 0.29 | 0.10 |
| Example 2 | | | |
| Example 2 | 0.10 | 0.09 | 0.02 |
| Example 3 | 0.25 | 0.09 | 0.03 |
| Example 4 | 0.50 | 0.09 | 0.02 |
| Example 5 | 0.75 | 0.10 | 0.01 |

The rules of Examples 2 to 5 and Comparative Example 2 are consistent with those of Example 1 and Comparative Example 1. The residual oil contents of the solid phase particles after drying are less than 0.3%, and the residual oil contents of the solid phase particles after thermal desorption are less than 0.1%; and the recovery rates of crude oil are above 95%, while the cyclohexane can be recycled.

### Examples 6 to 13

A simulated petroleum sludge (having an oil content of 25 wt %, a water content of 20 wt %, a solid content of 55 wt %, and an asphaltene content of 2.5 wt %) was taken as an example. Dodecylbenzene sulfonic acid (DBSA) was dissolved in toluene to prepare 0.10%, 0.25%, 0.50%, 0.75%, 1.00%, 1.25%, 1.50%, and 2.00% DBSA-toluene solutions (where 0.10%, 0.25%, 0.50%, 0.75%, 1.00%, 1.25%, 1.50%, and 2.00% were percentages that a mass of the DBSA accounted for a total mass of the DBSA-toluene solution, respectively). 1 g of the petroleum sludge was respectively mixed with 1 g of the toluene solutions with different concentrations and then stirred at 500 r/min for 30 min. A resulting mixed systems were centrifuged in a centrifuge tube at 1,000 r/min for 10 min and then separated to obtain lower solid phase particles and upper oil-carrying liquid phases. The solid phase particles were washed with 0.5 g of toluene and then placed in an oven at 90° C., and residual oil contents of the dried solid phase particles are shown in Table 3. The upper oil-carrying liquid phases were subjected to rotary evaporation to recover crude oils and reuse toluene.

In this example, DBSA was used as the particle dispersant. In order to eliminate the influence of DBSA on dispersing asphaltenes, toluene, a desirable solvent for asphaltene, was used as the solvent.

### Comparative Example 3

The steps were the same as those in Example 6, except that the dodecylbenzene sulfonic acid (DBSA) was not added to prepare a 0% DBSA-toluene solution. The residual oil contents of the solid phase particles after drying are shown in Table 3.

TABLE 3
Residual oil contents of the solid phase particles after treatment

| | | Residual oil content |
|---|---|---|
| | | of the solid |
| | DBSA | phase particle |
| SN | concentration (%) | after drying (%) |
| Comparative Example 3 | 0 | 3.29 |
| Example 6 | 0.10 | 3.75 |
| Example 7 | 0.25 | 3.00 |
| Example 8 | 0.50 | 1.74 |
| Example 9 | 0.75 | 0.27 |
| Example 10 | 1.00 | 0.43 |
| Example 11 | 1.25 | 0.23 |
| Example 12 | 1.50 | 0.11 |
| Example 13 | 2.00 | 0.14 |

The results of Examples 6 to 13 and Comparative Example 3 show that for the petroleum sludge with agglomerated mineral particles, even if toluene is used as the solvent, the residual oil content of the solid phase particles after extraction is as high as 3.29%. After the addition of the particle dispersant dodecylbenzene sulfonic acid (DBSA), the residual oil contents of the solid phase particles are significantly reduced. Moreover, as the dosage of the particle dispersant increases, the residual oil contents of the solid phase particles show a decreasing trend and eventually level off, with the residual oil content reaching a minimum of 0.11%.

### Examples 14 to 21

A simulated petroleum sludge (having an oil content of 25 wt %, a water content 20 of wt %, a solid content of 55 wt %, and an asphaltene content of 2.5 wt %) was taken as an example. Polyoxyethylene alkyl ether carboxylic acid C₁₂E₉Ac was dissolved in toluene to prepare 0.10%, 0.25%, 0.50%, 0.75%, 1.00%, 1.25%, 1.50%, and 2.00% C₁₂E₉Ac-toluene solutions (where 0.10%, 0.25%, 0.50%, 0.75%, 1.00%, 1.25%, 1.50%, and 2.00% were percentages that a mass of the C₁₂E₉Ac accounted for a total mass of the C₁₂E₉Ac-toluene solution, respectively). 1 g of the petroleum sludge was respectively mixed with 1 g of the toluene solutions with different concentrations and then stirred at 500 r/min for 30 min. A resulting mixed systems were centrifuged in a centrifuge tube at 1,000 r/min for 10 min and then separated to obtain lower solid phase particles and upper oil-carrying liquid phases. The solid phase particles were washed with 0.5 g of toluene and then placed in an oven at 90° C., and residual oil contents of the dried solid phase particles are shown in Table 4. The upper oil-carrying liquid phases were subjected to rotary evaporation to recover crude oils and reuse toluene.

### Comparative Example 4

The steps were the same as those in Example 14, except that the polyoxyethylene alkyl ether carboxylic acid C₁₂E₉Ac was not added to prepare a 0% C₁₂E₉Ac-toluene solution. The residual oil contents of the solid phase particles after drying are shown in Table 4.

TABLE 4
Residual oil contents of the solid phase particles after treatment

| | | Residual oil content |
|---|---|---|
| | | of the solid |
| | C₁₂E₉Ac | phase particle |
| SN | concentration (%) | after drying (%) |
| Comparative Example 4 | 0 | 3.29 |
| Example 14 | 0.10 | 1.40 |
| Example 15 | 0.25 | 1.13 |
| Example 16 | 0.50 | 0.91 |
| Example 17 | 0.75 | 0.32 |
| Example 18 | 1.00 | 0.30 |
| Example 19 | 1.25 | 0.27 |
| Example 20 | 1.50 | 0.23 |
| Example 21 | 2.00 | 0.27 |

The rules of Examples 14 to 21 and Comparative Example 4 are consistent with those of Example 6 and Comparative Example 3, and the residual oil rate of the solid phase particles can be reduced to a minimum of 0.23%.

### Examples 22 to 28

A simulated petroleum sludge (having an oil content of 25 wt %, a water content of 20 wt %, a solid content of 55 wt %, and an asphaltene content of 2.5 wt %) was taken as an example. Polyoxyethylene alkyl ether carboxylic acid C₁₂E₉Ac was dissolved in cyclohexane to prepare 0.25%, 0.5%, 0.75%, 1%, 1.25%, 1.5%, and 2% C₁₂E₉Ac-cyclohexane solutions (where 0.25%, 0.5%, 0.75%, 1%, 1.25%, 1.5%, and 2% were percentages that a mass of the C₁₂E₉Ac accounted for a total mass of the C₁₂E₉Ac-cyclohexane solution, respectively). 1 g of the petroleum sludge was respectively mixed with 1 g of the cyclohexane solutions with different concentrations and then stirred at 500 r/min for 30 min. A resulting mixed systems were centrifuged in a centrifuge tube at 1,000 r/min for 10 min and then separated to obtain lower solid phase particles and upper oil-carrying liquid phases. The solid phase particles were washed with 0.5 g of cyclohexane and then placed in an oven at 90° C., and residual oil contents of the dried solid phase particles are shown in Table 5. The upper oil-carrying liquid phases were subjected to rotary evaporation to recover crude oils and reuse cyclohexane.

### Comparative Example 5

The steps were the same as those in Example 22, except that the polyoxyethylene alkyl ether carboxylic acid C₁₂E₉Ac was not added to prepare a 0% C₁₂E₉Ac-cyclohexane solution. The residual oil contents of the solid phase particles after drying are shown in Table 5.

TABLE 5
Residual oil contents of the solid phase particles after treatment

| | | Residual oil content |
|---|---|---|
| | | of the solid |
| | C₁₂E₉Ac | phase particle |
| SN | concentration (%) | after drying (%) |
| Comparative Example 5 | 0 | 3.12 |
| Example 22 | 0.25 | 1.55 |
| Example 23 | 0.50 | 1.64 |
| Example 24 | 0.75 | 1.25 |
| Example 25 | 1.00 | 0.98 |
| Example 26 | 1.25 | 0.79 |
| Example 27 | 1.50 | 0.56 |
| Example 28 | 2.00 | 0.62 |

The rules of Examples 22 to 28 and Comparative Example 5 are consistent with those of Examples 14 to 21 and Comparative Example 4 as well as Examples 6 to 13 and Comparative Example 3, and the residual oil rate of the solid phase particles can be reduced to a minimum of 0.56%.

### Examples 29 to 32

A simulated petroleum sludge (having an oil content of 25 wt %, a water content of 20 wt %, a solid content of 55 wt %, and an asphaltene content of 2.5 wt %) was taken as an example. Polyoxyethylene alkyl ether carboxylic acid C₁₂E₉Ac was dissolved in cyclohexane to prepare a 1% C₁₂E₉Ac-cyclohexane solution (where 1% was a percentage that a mass of the C₁₂E₉Ac accounted for a total mass of the C₁₂E₉Ac-cyclohexane solution). 1 g of the petroleum sludge was mixed with 1 g of the cyclohexane solution and then stirred at 500 r/min for 30 min. A resulting mixed system was centrifuged in a centrifuge tube at 500 r/min, 1,000 r/min, 2,000 r/min, and 3,000 r/min, respectively for 10 min and then separated to obtain lower solid phase particles and upper oil-carrying liquid phases. The solid phase particles were washed with 0.5 g of cyclohexane and then placed in an oven at 90° C., and residual oil contents of the dried solid phase particles are shown in Table 6. The upper oil-carrying liquid phases were subjected to rotary evaporation to recover crude oils and reuse cyclohexane.

TABLE 6
Residual oil contents of the solid phase particles after treatment

| | | Residual oil content |
|---|---|---|
| | | of the solid |
| | Centrifugal | phase particle |
| SN | speed (r/min) | after drying (%) |
| Example 29 | 500 | 2.21 |
| Example 30 | 1000 | 0.79 |
| Example 31 | 2000 | 1.78 |
| Example 32 | 3000 | 1.90 |

Examples 29 to 32 explore the effect of centrifugal speed on the residual oil content of the solid phase particles. At a low centrifugal speed (500 r/min), fine particles and asphaltene aggregates can not be separated, resulting in a high residual oil content of the solid phase particles. At higher centrifugal speeds (2,000 r/min to 3,000 r/min), asphaltene aggregates may settle and mix with the solid phase particles under the centrifugal force field, resulting in an increase in the residual oil content of the solid phase particles.

### Example 33

A petroleum sludge from Qinghai (having an oil content of 20 wt %, a water content of 15 wt %, a solid content of 65 wt %, and an asphaltene content of 2.5 wt %) was taken as an example. Polyoxyethylene alkyl ether carboxylic acid C₁₈E₉Ac was dissolved in cyclopentane to prepare a 2.5% C₁₈E₉Ac-cyclopentane solution (where 2.5% was a percentage that a mass of the C₁₈E₉Ac accounted for a total mass of the C₁₈E₉Ac-cyclopentane solution). 1 g of the petroleum sludge was mixed with 1 g of the cyclopentane solution and then stirred at 500 r/min for 30 min. A resulting mixed system was centrifuged in a centrifuge tube at 1,000 r/min for 10 min and then separated to obtain a lower solid phase particle and an upper oil-carrying liquid phase. The solid phase particle was washed with 1 g of cyclopentane and then placed in an oven at 80° C., and a residual oil content of the dried solid phase particle was 0.27%. The upper oil-carrying liquid phase was subjected to rotary evaporation to recover a crude oil and reuse cyclopentane.

### Example 34

A petroleum sludge from Qinghai (having an oil content of 20 wt %, a water content of 15 wt %, a solid content of 65 wt %, and an asphaltene content of 2.5 wt %) was taken as an example. Polyoxyethylene alkyl ether carboxylic acid C₁₂E_{2.5}Ac was dissolved in cyclopentane to prepare a 2.5% C₁₂E_{2.5}Ac-cyclopentane solution (where 2.5% was a percentage that a mass of the C₁₂E_{2.5}Ac accounted for a total mass of the C₁₂E_{2.5}Ac-cyclopentane solution). 1 g of the petroleum sludge was mixed with 1 g of the cyclopentane solution and then stirred at 500 r/min for 30 min. A resulting mixed system was centrifuged in a centrifuge tube at 1,000 r/min for 10 min and then separated to obtain a lower solid phase particle and an upper oil-carrying liquid phase. The solid phase particle was washed with 1 g of cyclopentane and then placed in an oven at 80° C., and a residual oil content of the dried solid phase particle was 0.46%. The upper oil-carrying liquid phase was subjected to rotary evaporation to recover a crude oil and reuse cyclopentane.

### Example 35

A petroleum sludge from Qinghai (having an oil content of 20 wt %, a water content of 15 wt %, a solid content of 65 wt %, and an asphaltene content of 2.5 wt %) was taken as an example. Polyoxyethylene alkyl ether carboxylic acid C₁₈E₂Ac was dissolved in cyclopentane to prepare a 2.5% C₁₈E₂Ac-cyclopentane solution (where 2.5% was a percentage that a mass of the C₁₈E₂Ac accounted for a total mass of the C₁₈E₂Ac-cyclopentane solution). 1 g of the petroleum sludge was mixed with 1 g of the cyclopentane solution and then stirred at 500 r/min for 30 min. A resulting mixed system was centrifuged in a centrifuge tube at 1,000 r/min for 10 min and then separated to obtain a lower solid phase particle and an upper oil-carrying liquid phase. The solid phase particle was washed with 1 g of cyclopentane and then placed in an oven at 80° C., and a residual oil content of the dried solid phase particle was 0.45%. The upper oil-carrying liquid phase was subjected to rotary evaporation to recover a crude oil and reuse cyclopentane.

### Example 36

A simulated petroleum sludge (having an oil content of 25 wt %, a water content of 20 wt %, a solid content of 65 wt %, and an asphaltene content of 2.5 wt %) was taken as an example. Polyoxypropylene polyoxyethylene alkyl ether carboxylic acid C₁₃P₃E_{5.5}Ac was dissolved in cyclopentane to prepare a 2.5% C₁₃P₃E_{5.5}Ac-cyclopentane solution (where 2.5% was a percentage that a mass of the C₁₃P₃E_{5.5}Ac accounted for a total mass of the C₁₃P₃E_{5.5}Ac-cyclopentane solution). 1 g of the petroleum sludge was mixed with 1 g of the cyclopentane solution and then stirred at 500 r/min for 30 min. A resulting mixed system was centrifuged in a centrifuge tube at 1,000 r/min for 10 min and then separated to obtain a lower solid phase particle and an upper oil-carrying liquid phase. The solid phase particle was washed with 1 g of cyclopentane and then placed in an oven at 80° C., and a residual oil content of the dried solid phase particle was 0.76%. The upper oil-carrying liquid phase was subjected to rotary evaporation to recover a crude oil and reuse cyclopentane.

### Examples 37 to 40

An petroleum sludge from Qinghai (having an oil content of 20 wt %, a water content of 15 wt %, a solid content of 65 wt %, and an asphaltene content of 2.5 wt %) was taken as an example. Dodecylbenzene sulfonic acid (DBSA) was dissolved in cyclohexane to prepare 0.5%, 1.0%, 1.5%, and 2.0% DBSA-cyclohexane solutions (where 0.5%, 1.0%, 1.5%, and 2.0% were percentages that a mass of the DBSA accounted for a total mass of the DBSA-cyclohexane solution, respectively). 1 g of the petroleum sludge was respectively mixed with 1 g of the cyclohexane solutions with different concentrations and then stirred at 500 r/min for 30 min. A resulting mixed systems were allowed to stand for 3 min under a gravity field and then separated to obtain lower solid phase particles and an upper oil-carrying liquid phases. The solid phase particles were washed with 0.5 g of cyclohexane and then placed in an oven at 80° C., and residual oil contents of the dried solid phase particles are shown in Table 7. The upper oil-carrying liquid phases were subjected to rotary evaporation to recover crude oils and reuse cyclohexane.

### Comparative Example 6

The steps were the same as those in Example 37, except that the dodecylbenzene sulfonic acid (DBSA) was not added to prepare a 0% DBSA-cyclohexane solution. The residual oil contents of the solid phase particles after drying are shown in Table 7.

TABLE 7
Residual oil contents of the solid phase particles after treatment

| | | Residual oil content |
|---|---|---|
| | | of the solid |
| | DBSA | phase particle |
| SN | concentration (%) | after drying (%) |
| Comparative Example 6 | 0 | 2.70 |
| Example 37 | 0.5 | 0.91 |
| Example 38 | 1.0 | 0.92 |
| Example 39 | 1.5 | 0.86 |
| Example 40 | 2.0 | 0.89 |

Examples 37 to 40 and Comparative Example 6 explore the effect of adding the dodecylbenzene sulfonic acid (DBSA) on the residual oil content of the solid phase particles. After the addition of DBSA, the residual oil rates of the solid phase particles decrease. This is due to the hydrogen bonds formed between the sulfonic acid groups on the DBSA and the silanol groups on the particles, which are adsorbed onto the particles and provide repulsion between the particles. This promotes particle dispersion, thereby releasing asphaltenes and reducing the residual oil content of the solid phase particles. As the amount of DBSA added increases, the residual oil content of the particles does not change significantly.

### Examples 41 to 44

A petroleum sludge from Qinghai (having an oil content of 20 wt %, a water content of 15 wt %, a solid content of 65 wt %, and an asphaltene content of 2.5 wt %) was taken as an example. Polyoxyethylene alkyl ether carboxylic acid C₁₂E₉Ac was dissolved in cyclohexane to prepare 0.5%, 1.0%, 1.5%, and 2% C₁₂E₉Ac-cyclohexane solutions (where 0.5%, 1.0%, 1.5%, and 2% were percentages that a mass of the C₁₂E₉Ac accounted for a total mass of the C₁₂E₉Ac-cyclohexane solution, respectively). 1 g of the petroleum sludge was respectively mixed with 1 g of the cyclohexane solutions with different concentrations and then stirred at 500 r/min for 30 min. A resulting mixed system was allowed to stand for 3 min under a gravity field and then separated to obtain lower solid phase particles and an upper oil-carrying liquid phases. The solid phase particles were washed with 0.5 g of cyclohexane and then placed in an oven at 80° C., and residual oil contents of the dried solid phase particles are shown in Table 8. The upper oil-carrying liquid phases were subjected to rotary evaporation to recover crude oils and reuse cyclohexane.

### Comparative Example 7

The steps were the same as those in Example 41, except that the polyoxyethylene alkyl ether carboxylic acid C₁₂E₉Ac was not added to prepare a 0% C₁₂E₉Ac-cyclohexane solution. The residual oil contents of the solid phase particles after drying are shown in Table 8.

TABLE 8
Residual oil contents of the solid phase particles after treatment

| | | Residual oil content |
|---|---|---|
| | | of the solid phase |
| | C₁₂E₉Ac | particle after |
| SN | concentration (%) | drying (%) |
| Comparative Example 7 | 0 | 1.33 |
| Example 41 | 0.5 | 0.91 |
| Example 42 | 1.0 | 0.59 |
| Example 43 | 1.5 | 0.84 |
| Example 44 | 2.0 | 0.80 |

Examples 41 to 44 and Comparative Example 7 explore the effect of adding the polyoxyethylene alkyl ether carboxylic acid C₁₂E₉Ac on the residual oil content of the solid phase particles. After the addition of C₁₂E₉Ac, the residual oil rates of the solid phase particles decreased This is due to the hydrogen bonds formed between the carboxyl and ethoxy groups on C₁₂E₉Ac and the silicone hydroxyl groups on the particles, which are adsorbed onto the particles and provide repulsion between the particles. This promotes particle dispersion, thereby releasing asphaltenes and reducing the residual oil content of the solid phase particles. As the amount of C₁₂E₉Ac added increases, the residual oil content of the particles does not change significantly.

### Examples 45 to 46

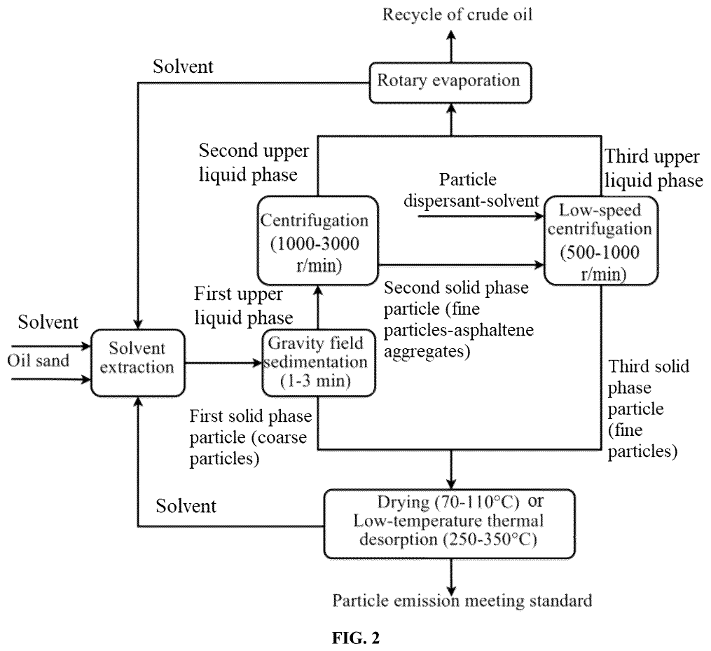

A low-quality oil sand from Canada (having an oil content of 5.17 wt %, a water content of 4.44 wt %, a solid content 90.39 wt %, and an asphaltene content of 0.50 wt %) was taken as an example. As shown in FIG. 2, the sample went through two steps of solvent extraction: a primary solvent extraction which did not involve the mineral particle agglomeration, and a pure solvent extraction was conducted to separate coarse particles; and a secondary solvent extraction targeted the agglomerated fine particles in the sample. Dodecylbenzene sulfonic acid (DBSA) and polyoxyethylene alkyl ether carboxylic acid C₁₂E₉Ac were dissolved in cyclohexane respectively to prepare a 0.5% DBSA-cyclohexane solution (where 0.5% was a percentage that a mass of the DBSA accounted for a total mass of the DBSA-cyclohexane solution) and a 1% C₁₂E₉Ac-cyclohexane solution (where 1% was a percentage that a mass of the C₁₂E₉Ac accounted for a total mass of the C₁₂E₉Ac-cyclohexane solution). 1 g of the oil sand fine particles were respectively mixed with 1 g of the cyclohexane solutions with different particle dispersants and then stirred at 500 r/min for 30 min. A resulting mixed system was settled under a gravity field for 10 min and then separated to obtain lower solid phase particles and upper oil-carrying liquid phases. The solid phase particles were washed with 0.5 g of cyclohexane and then placed in an oven at 80° C., and residual oil contents of the dried solid phase particles are shown in Table 9. The upper oil-carrying liquid phases were subjected to rotary evaporation to recover crude oils and reuse cyclohexane.

### Comparative Example 8

The steps were the same as those in Example 45, except that no particle dispersant was added during the secondary solvent extraction. The residual oil contents of the solid phase particles after drying are shown in Table 9.

TABLE 9
Residual oil contents of the solid phase particles after treatment

| | | Residual oil content |
|---|---|---|
| | | of the solid phase |
| | | particle after |
| SN | Extraction solvent | drying (%) |
| Comparative Example 8 | Cyclohexane | 4.34 |
| Example 45 | 0.5% DBSA- | 0.89 |
| | cyclohexane solution | |
| Example 46 | 1% C₁₂E₉Ac- | 0.84 |
| | cyclohexane solution | |

As shown in Table 9, during the secondary extraction, for the agglomerated fine particles, the oil content of the solid phase particle is higher when no particle dispersant is added. This is due to the large degree of aggregation of the fine particles at this time, and the trapped asphaltenes can not be released. When the particle dispersants, dodecylbenzene sulfonic acid (DBSA) and polyoxyethylene alkyl ether carboxylic acid C₁₂E₉Ac, are added respectively, the dispersed particle aggregates release asphaltenes, thereby reducing the oil content.

### Example 47

A certain oil sand from Canada (having an oil content of 10.7 wt %, a water content of 1.5 wt %, a solid content of 87.8 wt %, and an asphaltene content of 2.52 wt %) was taken as an example. Dodecylbenzene sulfonic acid (DBSA) was dissolved in cyclohexane to prepare a 0.5% DBSA-cyclohexane solution (where 0.5% was a percentage that a mass of the DBSA accounted for a total mass of the DBSA-cyclohexane solution). 1 g of the oil sand fine particles were mixed with 1 g of the cyclohexane solution and then stirred at 500 r/min for 30 min. A resulting mixed system was allowed to stand for 5 min under a gravity field and then separated to obtain a lower solid phase particle and an upper oil-carrying liquid phase. The solid phase particle was washed with 0.5 g of cyclohexane and then placed in an oven at 80° C., and a residual oil content of the dried solid phase particle is shown in Table 10. The upper oil-carrying liquid phase was subjected to rotary evaporation to recover a crude oil and reuse cyclohexane.

### Comparative Example 9

The steps were the same as those in Example 47, except that no particle dispersant was added during the secondary solvent extraction. The residual oil contents of the solid phase particles after drying are shown in Table 10.

TABLE 10
Residual oil contents of the solid phase particles after treatment

| | | Residual oil content |
|---|---|---|
| | | of the solid phase |
| | | particle after |
| SN | Extraction solvent | drying (%) |
| Comparative Example 9 | Cyclohexane | 0.8 |
| Example 47 | 0.5% DBSA- | 0.068 |
| | cyclohexane solution | |

The rules shown in Table 10 were consistent with those in Table 9. During the second extraction, for the agglomerated fine particles, the oil content of the solid phase particles is higher when no particle dispersant is added. This is due to the large degree of aggregation of the fine particles at this time, and the trapped asphaltenes can not be released. When the particle dispersant, dodecylbenzene sulfonic acid (DBSA), is added, the dispersed particle aggregates release asphaltenes, thereby reducing the oil content.

Although the above examples have described the present disclosure in detail, they are only a part of, not all of, the embodiments of the present disclosure. Other embodiments may also be obtained by persons based on the examples without creative efforts, and all of these embodiments shall fall within the scope of the present disclosure.

What is claimed is:

1. A solvent extraction method for a petroleum sludge/oil sand assisted by a particle dispersant, comprising:
mixing a solution dissolved with the particle dispersant and the petroleum sludge/oil sand to obtain a mixture, and subjecting the mixture to solvent extraction and separation to obtain a solid phase particle and an oil-carrying liquid phase;
wherein the particle dispersant comprises one compound selected from the group consisting of a polyoxyethylene alkyl ether carboxylic acid, a polyoxypropylene polyoxyethylene alkyl ether carboxylic acid, and dodecylbenzene sulfonic acid; and
a solvent used in the solution dissolved with the particle dispersant comprises one or more selected from the group consisting of cycloalkane and toluene.

2. The solvent extraction method of claim 1, wherein the separation is conducted by a mode selected from the group consisting of gravity field sedimentation and centrifugation; the gravity field sedimentation is conducted for 0.5 min to 60 min; and the centrifugation is conducted at a speed of 500 r/min to 3,000 r/min for 3 min to 30 min.

3. The solvent extraction method of claim 1, wherein the petroleum sludge/oil sand has an oil content of 5 wt % to 30 wt %, a water content of 4 wt % to 20 wt %, and a solid content of 57 wt % to 92 wt %.

4. The solvent extraction method of claim 1 wherein a mass ratio of the petroleum sludge/oil sand to the solution dissolved with the particle dispersant is in a range of 1:(0.5-3).

5. The solvent extraction method of claim 1, wherein the cycloalkane comprises cyclohexane and/or cyclopentane.

6. The solvent extraction method of claim 1, wherein a mass of the particle dispersant accounts for not more than 2.5% of a mass of the solution dissolved with the particle dispersant.

7. The solvent extraction method of claim 1, wherein the solvent extraction is conducted under stirring; and the stirring is conducted at a speed of 300 r/min to 2,000 r/min for 10 min to 120 min.

8. The solvent extraction method of claim 1, wherein after obtaining the solid phase particle, the method further comprises subjecting the solid phase particle to washing and drying in sequence to obtain a dried solid phase particle; and the drying is conducted at a temperature of 70° C. to 110° C.

9. The solvent extraction method of claim 8, wherein after the drying, the method further comprises subjecting the dried solid phase particle to low-temperature thermal desorption to remove a residual solvent; and the low-temperature thermal desorption is conducted at a temperature of 250° C. to 350° C. for 30 min to 60 min.

10. The solvent extraction method of claim 1, wherein after obtaining the oil-carrying liquid phase, the method further comprises subjecting the oil-carrying liquid phase to rotary evaporation to obtain a crude oil and a solvent.

11. The solvent extraction method of claim 3 wherein a mass ratio of the petroleum sludge/oil sand to the solution dissolved with the particle dispersant is in a range of 1:(0.5-3).

12. The solvent extraction method of claim 5, wherein a mass of the particle dispersant accounts for not more than 2.5% of a mass of the solution dissolved with the particle dispersant.

13. The solvent extraction method of claim 2, wherein after obtaining the solid phase particle, the method further comprises subjecting the solid phase particle to washing and drying in sequence to obtain a dried solid phase particle; and the drying is conducted at a temperature of 70° C. to 110° C.
